(19) United States
(12) Patent Application Publication
(10) Pub. No.: US 2021/0103800 A1
(43) Pub. Date: Apr. 8, 2021

(54) CERTIFIED ADVERSARIAL ROBUSTNESS FOR DEEP REINFORCEMENT LEARNING

(71) Applicants: Ford Global Technologies, LLC, Dearborn, MI (US); MIT Technology Licensing Office, Cambridge, MA (US)

(72) Inventors: Bjoern Malte Luetjens, Somerville, MA (US); Michael F. Everett, Boston, MA (US); Jonathan P. How, Arlington, MA (US); Arpan Kusari, East Lansing, MI (US)

(73) Assignees: Ford Global Technologies, LLC, Dearborn, MI (US); MIT Technology Licensing Office, Cambridge, MA (US)

(21) Appl. No.: 16/595,175

(22) Filed: Oct. 7, 2019

(51) Int. Cl. G06N 3/04; G06N 3/08; G05D 1/00

(52) U.S. Cl. CPC G06N 3/0481; G05D 1/0276; G05D 1/0088; G06N 3/08

(57) ABSTRACT

The present disclosure describes systems and methods that include calculating one or more lower bound state-action values based on a corrupted observation and a predetermined perturbation parameter; and selecting an action corresponding to a lower bound state-action value having the highest value.

### BACKGROUND

Sensors are used to collect environmental data. For example, sensors may capture images, sound, vibration, and other physical characteristics. Once collected, the sensors can send the environmental data to other electronic devices for further action. Within reinforcement learning agents, the sensor data can represent an observed state.

### BRIEF DESCRIPTION OF THE DRAWINGS

FIG. 1 is a diagram of an example system for calculating lower bound state-action values based on an observed state and a predetermined perturbation parameter.

FIG. 2 is a diagram of an example deep neural network.

FIG. 3 is a diagram of an example environment being traversed by an agent.

FIG. 4 is a block diagram of a system for calculating lower bound state-action values based on an observed state and a predetermined perturbation parameter.

FIG. 5 is a flow diagram illustrating an example process for calculating lower bound state-action values based on an observed state and a predetermined perturbation parameter.

### DETAILED DESCRIPTION

Reinforcement Learning (RL) is a form of goal-directed machine learning. For example, an agent can learn from direct interaction with its environment without relying on explicit supervision and/or complete models of the environment. Reinforcement learning is a framework modeling the interaction between a learning agent and its environment in terms of states, actions, and rewards. At each time step, an agent receives a state, selects an action based on a policy, receives a scalar reward, and transitions to the next state. The state can be based on one or more sensor inputs indicative of the environmental data. The agent's goal is to maximize an expected cumulative reward. The agent may receive a positive scalar reward for a positive action and a negative scalar reward for a negative action. Thus, the agent “learns” by attempting to maximize the expected cumulative reward. While the agent is described within the context of a vehicle herein, it is understood that the agent may comprise any suitable reinforcement learning agent. For example, the agent may comprise a robot, a drone, a computer application, or the like.

A system comprises a computer including a processor and a memory. The memory includes instructions such that the processor is programmed to calculate one or more lower bound state-action values based on a corrupted observation and a predetermined perturbation parameter; and select an action corresponding to a lower bound state-action value having the highest value.

In other features, the processor is further programmed to calculate the one or more lower bound state-action values based on the corrupted observation, the predetermined parameter, and weights of a trained deep neural network.

In other features, the trained deep neural network comprises a convolutional neural network.

In other features, the predetermined perturbation parameter comprises a vector.

In other features, the processor is further programmed to actuate an agent based on the selected action.

In other features, the processor is further programmed to actuate an agent based on the selected action.

In other features, the agent comprises an autonomous vehicle.

In other features, the corrupted observation comprises corrupted sensor data.

In other features, the processor is further programmed to receive the corrupted sensor data from a vehicle sensor of a vehicle.

In other features, the processor is further programmed to provide the sensor data to the deep neural network.

A system comprises a vehicle including a vehicle system, the vehicle system comprising a computer including a processor and a memory. The memory includes instructions such that the processor is programmed to calculate one or more lower bound state-action values based on a corrupted observation and a predetermined perturbation parameter; and select an action corresponding to a lower bound state-action value having the highest value.

In other features, the processor is further programmed to calculate the one or more lower bound state-action values based on the corrupted observation, the predetermined parameter, and weights of a trained deep neural network.

In other features, the trained deep neural network comprises a convolutional neural network.

In other features, the predetermined perturbation parameter comprises a vector.

In other features, the processor is further programmed to actuate the vehicle system based on the selected action.

In other features, the vehicle comprises an autonomous vehicle.

In other features, the corrupted observation comprises corrupted sensor data.

In other features, the processor is further programmed to receive the corrupted sensor data from a vehicle sensor of the vehicle.

In other features, the processor is further programmed to provide the sensor data to the deep neural network.

A method comprises calculating one or more lower bound state-action values based on a corrupted observation and a predetermined perturbation parameter; and selecting an action corresponding to a lower bound state-action value having the highest value.

In other features, the method further includes calculating the one or more lower bound state-action values based on the corrupted observation, the predetermined parameter, and weights of a trained deep neural network.

In other features, the trained deep neural network comprises a convolutional neural network.

In other features, calculating the one or more lower bound state-action values further comprises calculating the one or more lower bound state-action values based on the corrupted observation and the predetermined perturbation parameter according to:

$$= - {‖ ϵ \cdot {A}_{j , :}^{( 0 )} ‖}_{q} + {A}_{j , :}^{( 0 )} {s}_{adv} + {b}_{j}^{( m )} + {\sum }_{k = 1}^{m - 1} {A}_{j , :}^{( k )} ( {b}^{( k )} - {H}_{j : ,}^{( k )} ) ,$$

where o represents element-wise multiplication, A represents a matrix including network weights and nonlinear activation (ReLU) functions for a corresponding deep neural network layer of an m-layer deep neural network, k represents the current layer of the m-layer deep neural network, b represents the bias for a corresponding action, H represents the lower/upper bounding factor, ε represents the predetermined perturbation parameter, s_{adv} represents the corrupted observation, j represents a corresponding action index, and q represents a selected norm.

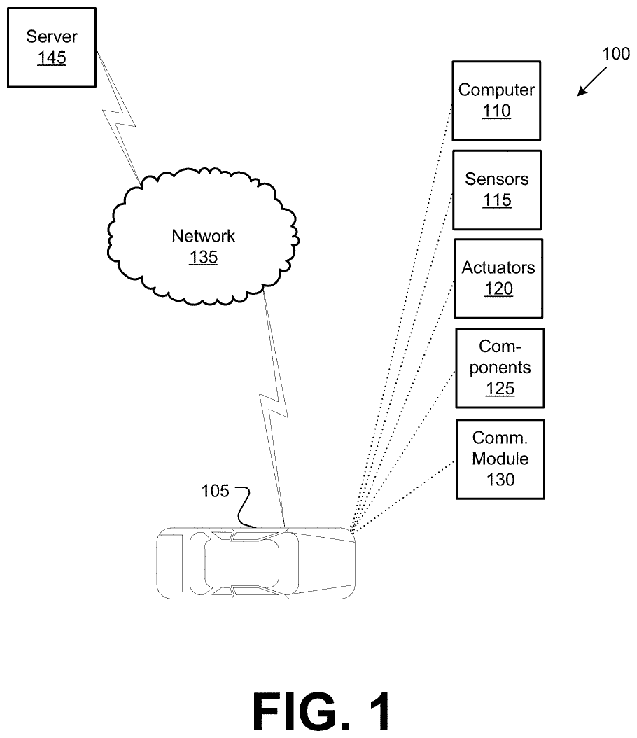

FIG. 1 is a block diagram of an example vehicle control system 100. The system 100 includes a vehicle 105, which is a land vehicle such as a car, truck, etc. The vehicle 105 includes a computer 110, vehicle sensors 115, actuators 120 to actuate various vehicle components 125, and a vehicle communications module 130. Via a network 135, the communications module 130 allows the computer 110 to communicate with a server 145.

The computer 110 includes a processor and a memory. The memory includes one or more forms of computer-readable media, and stores instructions executable by the computer 110 for performing various operations, including as disclosed herein.

The computer 110 may operate a vehicle 105 in an autonomous, a semi-autonomous mode, or a non-autonomous (manual) mode. For purposes of this disclosure, an autonomous mode is defined as one in which each of vehicle 105 propulsion, braking, and steering are controlled by the computer 110; in a semi-autonomous mode the computer 110 controls one or two of vehicles 105 propulsion, braking, and steering; in a non-autonomous mode a human operator controls each of vehicle 105 propulsion, braking, and steering.

The computer 110 may include programming to operate one or more of vehicle 105 brakes, propulsion (e.g., control of acceleration in the vehicle by controlling one or more of an internal combustion engine, electric motor, hybrid engine, hydrogen-fuel cell, etc.), steering, climate control, interior and/or exterior lights, etc., as well as to determine whether and when the computer 110, as opposed to a human operator, is to control such operations. Additionally, the computer 110 may be programmed to determine whether and when a human operator is to control such operations.

The computer 110 may include or be communicatively coupled to, e.g., via the vehicle 105 communications module 130 as described further below, more than one processor, e.g., included in electronic controller units (ECUs) or the like included in the vehicle 105 for monitoring and/or controlling various vehicle components 125, e.g., a powertrain controller, a brake controller, a steering controller, etc. Further, the computer 110 may communicate, via the vehicle 105 communications module 130, with a navigation system that uses the Global Position System (GPS). As an example, the computer 110 may request and receive location data of the vehicle 105. The location data may be in a known form, e.g., geo-coordinates (latitudinal and longitudinal coordinates).

The computer 110 is generally arranged for communications on the vehicle 105 communications module 130 and also with a vehicle 105 internal wired and/or wireless network, e.g., a bus or the like in the vehicle 105 such as a controller area network (CAN) or the like, and/or other wired and/or wireless mechanisms.

Via the vehicle 105 communications network, the computer 110 may transmit messages to various devices in the vehicle 105 and/or receive messages from the various devices, e.g., vehicle sensors 115, actuators 120, vehicle components 125, a human machine interface (HMI), etc. Alternatively or additionally, in cases where the computer 110 actually comprises a plurality of devices, the vehicle 105 communications network may be used for communications between devices represented as the computer 110 in this disclosure. Further, as mentioned below, various controllers and/or vehicle sensors 115 may provide data to the computer 110.

Vehicle sensors 115 may include a variety of devices such as are known to provide data to the computer 110. For example, the vehicle sensors 115 may include Light Detection and Ranging (lidar) sensor(s) 115, etc., disposed on a top of the vehicle 105, behind a vehicle 105 front windshield, around the vehicle 105, etc., that provide relative locations, sizes, and shapes of objects and/or conditions surrounding the vehicle 105. As another example, one or more radar sensors 115 fixed to vehicle 105 bumpers may provide data to provide and range velocity of objects (possibly including second vehicles 106), etc., relative to the location of the vehicle 105. The vehicle sensors 115 may further include camera sensor(s) 115, e.g. front view, side view, rear view, etc., providing images from a field of view inside and/or outside the vehicle 105.

The vehicle 105 actuators 120 are implemented via circuits, chips, motors, or other electronic and or mechanical components that can actuate various vehicle subsystems in accordance with appropriate control signals as is known. The actuators 120 may be used to control components 125, including braking, acceleration, and steering of a vehicle 105.

In the context of the present disclosure, a vehicle component 125 is one or more hardware components adapted to perform a mechanical or electro-mechanical function or operation—such as moving the vehicle 105, slowing or stopping the vehicle 105, steering the vehicle 105, etc. Non-limiting examples of components 125 include a propulsion component (that includes, e.g., an internal combustion engine and/or an electric motor, hydrogen fuel cell, etc.), a transmission component, a steering component (e.g., that may include one or more of a steering wheel, a steering rack, etc.), a brake component (as described below), a park assist component, an adaptive cruise control component, an adaptive steering component, a movable seat, etc.

In addition, the computer 110 may be configured for communicating via a vehicle-to-vehicle communication module or interface 130 with devices outside of the vehicle 105, e.g., through a vehicle-to-vehicle (V2V) or vehicle-to-infrastructure (V2X) wireless communications to another vehicle, to (typically via the network 135) a remote server 145. The module 130 could include one or more mechanisms by which the computer 110 may communicate, including any desired combination of wireless (e.g., cellular, wireless, satellite, microwave and radio frequency) communication mechanisms and any desired network topology (or topologies when a plurality of communication mechanisms are utilized). Exemplary communications provided via the module 130 include cellular, Bluetooth®, IEEE 802.11, dedicated short range communications (DSRC), and/or wide area networks (WAN), including the Internet, providing data communication services.

The network 135 includes one or more mechanisms by which a computer 110 may communicate with a server 145. Accordingly, the network 135 can be one or more of various wired or wireless communication mechanisms, including any desired combination of wired (e.g., cable and fiber) and/or wireless (e.g., cellular, wireless, satellite, microwave, and radio frequency) communication mechanisms and any desired network topology (or topologies when multiple communication mechanisms are utilized). Exemplary communication networks include wireless communication networks (e.g., using Bluetooth, Bluetooth Low Energy (BLE), IEEE 802.11, vehicle-to-vehicle (V2V) such as Dedicated Short-Range Communications (DSRC), etc.), local area networks (LAN) and/or wide area networks (WAN), including the Internet, providing data communication services.

The server 145 can be a computing device, i.e., including one or more processors and one or more memories, programmed to provide operations such as disclosed herein. Further, the server 145 can be accessed via the network 135, e.g., the Internet or some other wide area network.

A computer 110 can receive and analyze data from sensors 115 substantially continuously, periodically, and/or when instructed by a server 145, etc. Further, object classification or identification techniques can be used, e.g., in a computer 110 based on lidar sensor 115, camera sensor 115, etc., data, to identify a type of object, e.g., vehicle, person, rock, pothole, bicycle, motorcycle, etc., as well as physical features of objects.

With the present context, the vehicle 105 can be referred to as an agent. The computer 110 is configured to implement a neural network-based reinforcement learning procedure as described herein. The computer 110 generates a set of state-action values (Q-values) as outputs for an observed input state. The computer 110 can select an action corresponding to a maximum state-action value, e.g., the highest state-action value. The computer 110 obtains sensor data from the sensors 115 that corresponds to an observed input state.

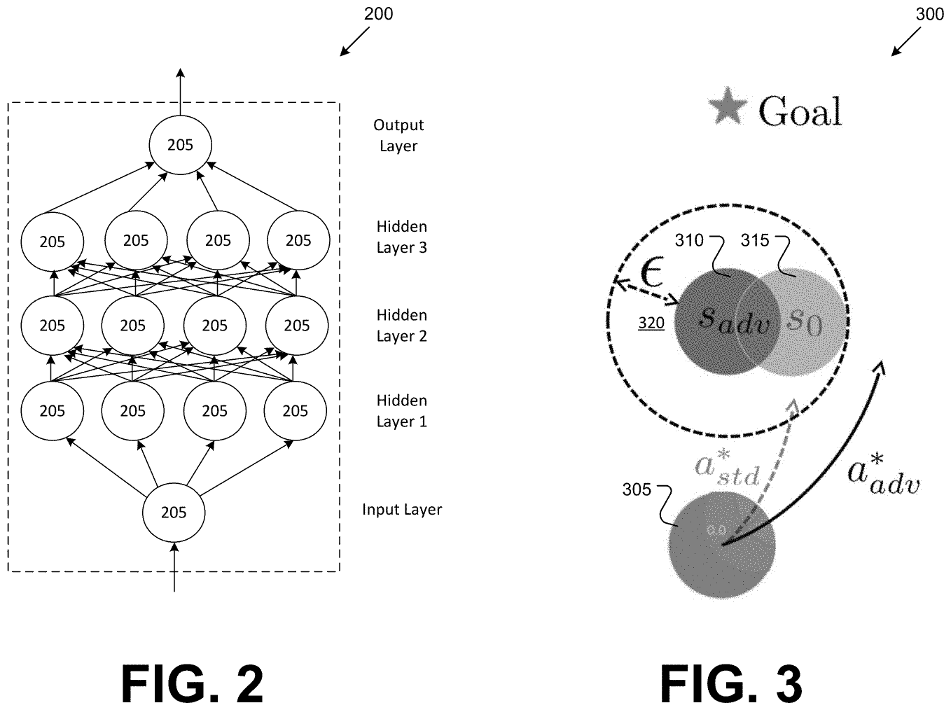

FIG. 2 is a diagram of an example deep neural network (DNN) 200. The DNN 200 can be a software program that can be loaded in memory and executed by a processor included in computer 110, for example. In an example implementation, the DNN 200 can include any suitable neural network capable of employing reinforcement learning techniques. For example, the DNN 200 may comprise a convolutional neural network. The DNN 200 includes multiple neurons 205, and the neurons 205 are arranged so that the DNN 200 includes an input layer, one or more hidden layers, and an output layer. Each layer of the DNN 200 can include a plurality of neurons 205. While FIG. 2 illustrates three (3) hidden layers, it is understood that the DNN 200 can include additional or fewer hidden layers. The input and output layers may also include more than one (1) neuron 205.

The neurons 205 are sometimes referred to as artificial neurons 205, because they are designed to emulate biological, e.g., human, neurons. A set of inputs (represented by the arrows) to each neuron 205 are each multiplied by respective weights. The weighted inputs can then be summed in an input function to provide, possibly adjusted by a bias, a net input. The net input can then be provided to activation function, which in turn provides a connected neuron 205 an output. The activation function can be a variety of suitable functions, typically selected based on empirical analysis. As illustrated by the arrows in FIG. 2, neuron 205 outputs can then be provided for inclusion in a set of inputs to one or more neurons 205 in a next layer.

The DNN 200 can be trained to accept sensor 115 data, e.g., from the vehicle 101 CAN bus or other network, as input and generate a state-action value, e.g., reward value, based on the input. The DNN 200 can be trained with training data, e.g., a known set of sensor inputs, to train the agent for the purposes of determining an optimal policy. In one or more implementations, the DNN 200 is trained via the server 145, and the trained DNN 200 can be transmitted to the vehicle 105 via the network 135. Weights can be initialized by using a Gaussian distribution, for example, and a bias for each neuron 205 can be set to zero. Training the DNN 200 can including updating weights and biases via suitable techniques such as back-propagation with optimizations.

During operation, the vehicle 105 computer 110 obtains sensor data from the sensors 115 and provides the data as input to the DNN 200. Once trained, the DNN 200 can accept the sensor input and provide, as output, one or more state-action values (Q-values) based on the sensed input. During execution of the DNN 200, the state-action values can be generated for each action available to the agent within the environment.

FIG. 3 illustrates an example environment 300 in which an autonomous agent 305, such as the vehicle 105, is traversing. For instance, the autonomous agent 305 is attempting to travel through the environment 300 to reach the goal without encountering, e.g., colliding with, any obstacles. The environment 300 includes an obstacle s_{adv} located at a first position 310. However, the sensor data received by the computer 110 indicates that the obstacle, referred to as s₀, is located at a second position 315 due to corrupted sensor data. As described in greater detail herein, the computer 110 is configured to select path a*_{adv} rather than path a*_{std}. by accounting for perturbation within the sensor data. For example, the computer 110 is configured to account for the obstacle s_{adv} by considering that the obstacle s_{adv} may be located anywhere within a space 320 as defined by a predetermined perturbation parameter ε. The space 320 may correspond to a unit ball defined about s_{adv}. As described below, the computer 110 can calculate one or more lower bound state-action values using the predetermined perturbation parameter ε, which can increase the robustness of the agent maneuvering within an environment.

The agent is configured to select a discrete action based on a state corresponding to the sensor data. For example, using the optimal policy generated during training, the agent selects an action to maximize its reward corresponding to the state-action values. Within the present context, the DNN 200 comprises a m-layer neural network with m−1 hidden layers, where m is an integer greater than or equal to 2. Each discrete action aⱼ has a state-action value defined by Equation 1:

Q^{j}= [symbol] [Σₜ₌₀^{T}γ^{t}rₜ], Eq. 1

where Q represents the state-action value corresponding to the discrete action aⱼ, [symbol] represents an expectation, γ^{t} represents a discount factor at time t, and rₜ represents a reward at time t. The subscript j can refer to the j-th output of the DNN 200.

As described herein, the computer 110 is configured to calculate a certified lower bound given a bounded perturbation associated with the sensor data with respect to a true state. The certified lower bound for a discrete action aⱼ can be defined by Equation 2:

$${Q}_{L}^{j} := {min}_{s ∈ {B}_{p} ( {s}_{adv} , ϵ )} {Q}_{j} ( s , {a}_{j} ) , \qquad Eq . 2$$

for all possible states s within a perturbation state based on the sensor data s_{adv}, where Q_{L}^{j} represents the certified lower bound of the state-action value corresponding to discrete action aⱼ given state s, Qⱼ(s, aⱼ) represents the state-action value corresponding to the discrete action aⱼ given state s, and the bounded perturbation space Bₚ(s_{adv}, ε) is defined by Equation 3:

Bₚ(s_{adv}, ε):={s:∥s−s_{adv}∥ₚ≤ϵ} Eq. 3.

where p represents a selected norm.

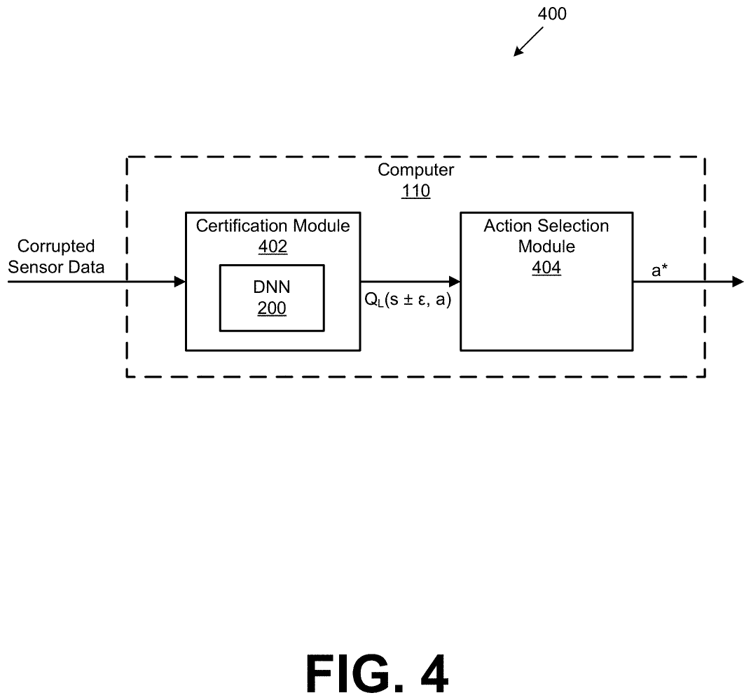

FIG. 4 illustrates an example implementation of a system 400 for determining an action that maximizes a state-action value under a worst-case perturbation of the sensor data. As shown, the system 400 includes a certification module 402 and an action selection module 404. The certification module includes a trained DNN 200. The certification module 402 can be a software program that can be loaded in memory and executed by a processor included in computer 110, for example. The certification module 402 receives, as input, corrupted sensor data representing an observed state. As described herein, the certification module 402 can use a predetermined perturbation parameter ε to calculate one or more state-action values to account for the corrupted sensor data. The predetermined perturbation parameter ε may be determined through empirical testing based on various physical environments that can be encountered by the agent and/or set during testing.

As set forth in the equations below, the certification module 402 uses the weights of the trained DNN 200 to calculate the bounded state-action values. For example, the certification module 402 computes a lower bound state-action value for each discrete action. The lower bound state-action value can be referred to as Q_{L}(s±ε, a), which is input to the action selection module 404.

The action selection module 404 can be a software program that can be loaded in memory and executed by a processor included in computer 110, for example. The action selection module 404 selects an action for the agent based on the received state-action value. For example, the action selection module 404 can select an action corresponding to the highest state-action value. Within the present context, the action selection module 404 selects an optimal action, referred to as a*, corresponding to the highest lower bound state-action value calculated by the certification module 402. The computer 110 can provide one or more actuation signals to the actuators 120 to cause the agent to perform the selected optimal action.

The optimal action a* can be the action with the highest state-action value under the worst-case perturbation, which is defined in Equation 4:

$${a}^{*} = {argmax}_{a} {min}_{s ∈ {B}_{p} ( {s}_{adv} , ϵ )} Q ( s , a ) = {argmax}_{{a}_{j}} {Q}_{L}^{j} ( {s}_{adv} , {a}_{j} ) , \qquad Eq . 4$$

in which Q_{L}^{j} represents the calculated lower bounds for all states within the bounded perturbation space Bₚ(s_{adv}, ε). The lower bounds for all states within the bounded perturbation space can be calculated by the certification module 402 according to Equations 5 through 9:

$$\begin{matrix}{Q}_{L}^{j} ( {s}_{adv} , {a}_{j} ) = {min}_{s ∈ {B}_{p} ( {s}_{adv} , ϵ )} ( {A}_{j , :}^{( 0 )} s + {b}_{j}^{( m )} + {\sum }_{k = 1}^{m - 1} {A}_{j , :}^{( k )} ( {b}^{( k )} - {H}_{: , j}^{( k )} ) ) & Eq . 5 \\ = ( {min}_{s ∈ {B}_{p} ( {s}_{adv} , ϵ )} {A}_{j , :}^{( 0 )} s ) + {b}_{j}^{( m )} + {\sum }_{k = 1}^{m - 1} {A}_{j , :}^{( k )} ( {b}^{( k )} - {H}_{: , j}^{( k )} ) & Eq . 6 \\ = ( {min}_{y ∈ {B}_{p} ( 0 , 1 )} {A}_{j , :}^{( 0 )} ( y \cdot ϵ ) ) + {A}_{j , :}^{( 0 )} {s}_{adv} + {b}_{j}^{( m )} + {\sum }_{k = 1}^{m - 1} {A}_{j , :}^{( k )} ( {b}^{( k )} - {H}_{: , j}^{( k )} ) & Eq . 7 \\ = ( {min}_{y ∈ {B}_{p} ( 0 , 1 )} ( ϵ \cdot {A}_{j , :}^{( 0 )} ) y ) + {A}_{j , :}^{( 0 )} {s}_{adv} + {b}_{j}^{( m )} + {\sum }_{k = 1}^{m - 1} {A}_{j , :}^{( k )} ( {b}^{( k )} - {H}_{: , j}^{( k )} ) & Eq . 8 \\ = - {‖ ϵ \cdot {A}_{j , :}^{( 0 )} ‖}_{q} + {A}_{j , :}^{( 0 )} {s}_{adv} + {b}_{j}^{( m )} + {\sum }_{k = 1}^{m - 1} {A}_{j , :}^{( k )} ( {b}^{( k )} - {H}_{: , j}^{( k )} ) , & Eq . 9\end{matrix}$$

where o represents element-wise multiplication, A represents a matrix including network weights and nonlinear activation (ReLU) functions for a corresponding DNN 200 layer, k represents the current layer of the m-layer neural network, b represents the bias for a corresponding action, H represents the lower/upper bounding factor, y is an element of Bₚ(0,1), the variable j represents the corresponding action index, the variable m represents the m-th layer of the DNN 200, and the variable q represents a selected norm. For example, from Equation 6 to Equation 7, s:=yoε+s_{adv} is substituted to shift and re-scale the observed state data to within a unit ball around zero, y ϵBₚ(0,1). The maximization in Equation 8 reduces to a q-norm in Equation 9 by the definition of the dual norm ∥z∥*={sup_{y}z^{T}y | ∥y∥ ≤1} and the fact that the 1_{q} norm is dual of 1ₚ norm for p,q ϵ [1,∞) with 1/p+1/q=1. In one or more implementations, the predetermined perturbation parameter ε comprises a vector.

Once the certification module 402 calculates the lower bound for each state-action value, the calculated state-action values are provided to the action selection module 404. The action selection module 404 selects the action a* corresponding to the highest calculated state-action value. Based on the selected action a*, the computer 110 generates one or more agent, e.g., vehicle 105, control signals to cause the agent to operate according to the action a*.

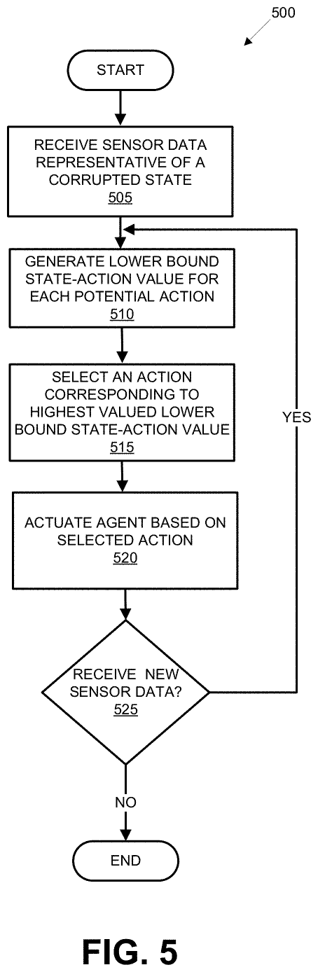

FIG. 5 is a flowchart of an exemplary process 500 for determining an action based on a detected, e.g., observed, state. The state can correspond to data detected by the sensors 115. Blocks of the process 500 can be executed by the computer 110. The process 500 begins at block 505 in which the computer 110 receives corrupted sensor data from the sensors 115.

At block 510, the certification module 402 generates lower bound state-action values based on the corrupted sensor data and the perturbation parameter ε. For example, as set forth in the equations above, the corrupted sensor data can be bounded by perturbation parameter ε, i.e., s±ε. The lower bound state-action values account for potential perturbations within the received sensor data. The lower bound state-action Q_{L} values can be provided to the action selection module 404. At block 515, the action selection module 404 selects an action a* corresponding to the lower bound state-action value having the highest value.

At block 520, the computer 110 causes the agent to perform the action a*. For example, the computer 110 can cause one or more vehicle systems of the vehicle 105 to actuate to cause the vehicle 105 to perform the action a*. At block 525, the computer 110 determines whether new sensor data has been received. If new sensor data has been received, the process 500 returns to block 510. Otherwise, the process 500 ends.

In general, the computing systems and/or devices described may employ any of a number of computer operating systems, including, but by no means limited to, versions and/or varieties of the Ford Sync® application, AppLink/Smart Device Link middleware, the Microsoft Automotive® operating system, the Microsoft Windows® operating system, the Unix operating system (e.g., the Solaris® operating system distributed by Oracle Corporation of Redwood Shores, Calif.), the AIX UNIX operating system distributed by International Business Machines of Armonk, N.Y., the Linux operating system, the Mac OSX and iOS operating systems distributed by Apple Inc. of Cupertino, Calif., the BlackBerry OS distributed by Blackberry, Ltd. of Waterloo, Canada, and the Android operating system developed by Google, Inc. and the Open Handset Alliance, or the QNX® CAR Platform for Infotainment offered by QNX Software Systems. Examples of computing devices include, without limitation, an on-board vehicle computer, a computer workstation, a server, a desktop, notebook, laptop, or handheld computer, or some other computing system and/or device.

Computers and computing devices generally include computer-executable instructions, where the instructions may be executable by one or more computing devices such as those listed above. Computer executable instructions may be compiled or interpreted from computer programs created using a variety of programming languages and/or technologies, including, without limitation, and either alone or in combination, Java™, C, C++, Matlab, Simulink, Stateflow, Visual Basic, Java Script, Perl, HTML, TensorFlow, PyTorch, Keras, etc. Some of these applications may be compiled and executed on a virtual machine, such as the Java Virtual Machine, the Dalvik virtual machine, or the like. In general, a processor (e.g., a microprocessor) receives instructions, e.g., from a memory, a computer readable medium, etc., and executes these instructions, thereby performing one or more processes, including one or more of the processes described herein. Such instructions and other data may be stored and transmitted using a variety of computer readable media. A file in a computing device is generally a collection of data stored on a computer readable medium, such as a storage medium, a random-access memory, etc.

Memory may include a computer-readable medium (also referred to as a processor-readable medium) that includes any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random-access memory (DRAM), which typically constitutes a main memory. Such instructions may be transmitted by one or more transmission media, including coaxial cables, copper wire and fiber optics, including the wires that comprise a system bus coupled to a processor of an ECU. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

With regard to the media, processes, systems, methods, heuristics, etc. described herein, it should be understood that, although the steps of such processes, etc. have been described as occurring according to a certain ordered sequence, such processes may be practiced with the described steps performed in an order other than the order described herein. It further should be understood that certain steps may be performed simultaneously, that other steps may be added, or that certain steps described herein may be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent to those of skill in the art upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future embodiments. In sum, it should be understood that the invention is capable of modification and variation and is limited only by the following claims.

All terms used in the claims are intended to be given their plain and ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary.

What is claimed is:

1. A system comprising a computer including a processor and a memory, the memory including instructions such that the processor is programmed to:
calculate one or more lower bound state-action values based on a corrupted observation and a predetermined perturbation parameter; and
select an action corresponding to a lower bound state-action value having the highest value.

2. The system of claim 1, wherein the processor is further programmed to:
calculate the one or more lower bound state-action values based on the corrupted observation, the predetermined parameter, and weights of a trained deep neural network.

3. The system of claim 2, wherein the trained deep neural network comprises a convolutional neural network.

4. The system of claim 1, wherein the predetermined perturbation parameter comprises a vector.

5. The system of claim 1, wherein the processor is further programmed to:
actuate an agent based on the selected action.

6. The system of claim 4, wherein the agent comprises an autonomous vehicle.

7. The system of claim 1, wherein the corrupted observation comprises corrupted sensor data.

8. The system of claim 7, wherein the processor is further programmed to:
receive the corrupted sensor data from a vehicle sensor of a vehicle.

9. A system comprising:
a vehicle including a vehicle system, the vehicle system comprising a computer including a processor and a memory, the memory including instructions such that the processor is programmed to:
calculate one or more lower bound state-action values based on a corrupted observation and a predetermined perturbation parameter; and
select an action corresponding to a lower bound state-action value having the highest value.

10. The system of claim 9, wherein the processor is further programmed to:
calculate the one or more lower bound state-action values based on the corrupted observation, the predetermined parameter, and weights of a trained deep neural network.

11. The system of claim 10, wherein the trained deep neural network comprises a convolutional neural network.

12. The system of claim 9, wherein the predetermined perturbation parameter comprises a vector.

13. The system of claim 9, wherein the processor is further programmed to:
actuate the vehicle system based on the selected action.

14. The system of claim 13, wherein the vehicle comprises an autonomous vehicle.

15. The system of claim 9, wherein the corrupted observation comprises corrupted sensor data.

16. The system of claim 15, wherein the processor is further programmed to:
receive the corrupted sensor data from a vehicle sensor of the vehicle.

17. A method, comprising:
calculating one or more lower bound state-action values based on a corrupted observation and a predetermined perturbation parameter; and
selecting an action corresponding to a lower bound state-action value having the highest value.

18. The method as recited in claim 17, further comprising:
calculating the one or more lower bound state-action values based on the corrupted observation, the predetermined parameter, and weights of a trained deep neural network.

19. The method of claim 18, wherein the trained deep neural network comprises a convolutional neural network.

20. The method of claim 17, wherein calculating the one or more lower bound state-action values further comprises calculating the one or more lower bound state-action values based on the corrupted observation and the predetermined perturbation parameter according to:
$$= - {‖ ϵ \cdot {A}_{j , :}^{( 0 )} ‖}_{q} + {A}_{j , :}^{( 0 )} {s}_{adv} + {b}_{j}^{( m )} + {\sum }_{k = 1}^{m - 1} {A}_{j , :}^{( k )} ( {b}^{( k )} - {H}_{: , j}^{( k )} ) ,$$
where o represents element-wise multiplication, A represents a matrix including network weights and nonlinear activation (ReLU) functions for a corresponding deep neural network layer of an m-layer deep neural network, k represents the current layer of the m-layer deep neural network, b represents the bias for a corresponding action, H represents the lower/upper bounding factor, ε represents the predetermined perturbation parameter, s_{adv} represents the corrupted observation, j represents a corresponding action index, and q represents a selected norm.
